(19) United States
(12) Patent Application Publication
(10) Pub. No.: US 2010/0167117 A1
(43) Pub. Date: Jul. 1, 2010

(54) BATTERY INCLUDING ELECTRICALLY CONDUCTIVE PHOSPHATE GLASS COMPONENTS

(76) Inventors: Matthew J. Maroon, Metamora, IL (US); Kurtis C. Kelley, Washington, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/377,795

(22) PCT Filed: Aug. 17, 2006
(86) PCT No.: PCT/US06/32241

§ 371 Date: Feb. 17, 2009

(51) Int. Cl. H01M 2/00; H01M 4/02

(52) U.S. Cl. 429/163; 429/209; 429/220

(57) ABSTRACT

An electrode plate for an energy storage device includes a current collector fabricated at least partially from an electrically conductive phosphate glass. A chemically active material may be disposed on the current collector.

### DESCRIPTION OF THE INVENTION

1. Technical Field

This application relates generally to materials for use in energy storage device components and, more particularly, to phosphate glass components for a lead acid battery.

2. Background of the Invention

Various types of batteries exist. Many of these battery types store and release electrical energy by taking advantage of potential differences provided by certain electrochemical reactions. In a lead acid battery, for example, each cell includes a stack of alternating positive and negative plates. Each of these plates includes a current collector and a chemically active material disposed on the current collector. The electrochemical reaction, which produces the electrons that enable operation of the battery, occurs in the chemically active paste. The current collectors collect the electrons generated by the electrochemical reaction and transfer these electrons as current to a network of electrically conductive elements associated with the battery. Ultimately, this network of conductive elements carries the current outside of the battery and enables the battery to do useful work. This network of electrically conductive elements may include, for example, bus bars, terminal leads, cell connectors, electrically conductive bonding agents, and any other current-carrying, electrically conductive components that may be provided within a battery.

Traditionally, many of the electrically conductive components in batteries are made from materials that may be heavy or susceptible to corrosion and other performance limiting processes. In lead acid batteries, for example, many of the electrically conductive components are made from lead. All components manufactured from lead, however, experience two major problems. First, due to the intrinsic instability of lead in certain battery environments (e.g., in a lead acid battery), the lead components are susceptible to corrosion. This corrosion can decrease the current carrying capability of the battery and, therefore, adversely affect battery performance. Second, lead is a heavy material. As a result, each component made from lead can add a significant amount of weight to the battery. The added weight can adversely affect the gravimetric power and energy density of the battery. Similar disadvantages exist among the various electrically conductive materials used in batteries other than lead acid batteries.

Thus, there is a need for energy storage devices (e.g., batteries) that include electrically conductive components made from materials with improved performance characteristics. In lead acid batteries, for example, there is a need for electrically conductive materials that are lighter than lead and more resistant to the harsh, acidic environment present in lead acid batteries.

The presently disclosed systems and methods are directed to overcoming one or more of the problems set forth above.

### SUMMARY OF THE INVENTION

In accordance with one aspect, the present disclosure is directed toward an electrode plate for an energy storage device. The electrode plate may include a current collector fabricated at least partially from an electrically conductive phosphate glass. A chemically active material may be disposed on the current collector.

According to another aspect, the present disclosure is directed toward an energy storage device. The energy storage device may include a housing and at least one cell disposed within the housing. The at least one cell may include one or more positive electrode plates and one or more negative electrode plates. At least one component of the energy storage device is fabricated from a material including an electrically conductive phosphate glass.

In accordance with yet another aspect, the present disclosure includes a lead acid battery. The lead acid battery may include a housing and at least one cell disposed within the housing. The at least one cell may include at least one positive plate and at least one negative plate. An electrolytic solution may be disposed within a volume between the positive and negative plates. The at least one positive plate or the at least one negative plate may further include a current collector fabricated from a material including electrically conductive phosphate glass. A chemically active material may be disposed on the current collector.

### BRIEF DESCRIPTION OF THE DRAWINGS

FIG. 1 provides diagrammatic illustration of an energy storage device, according to an exemplary disclosed embodiment.

FIG. 2 provides a diagrammatic illustration of a current collector, according to an exemplary disclosed embodiment.

### DESCRIPTION OF THE EMBODIMENTS

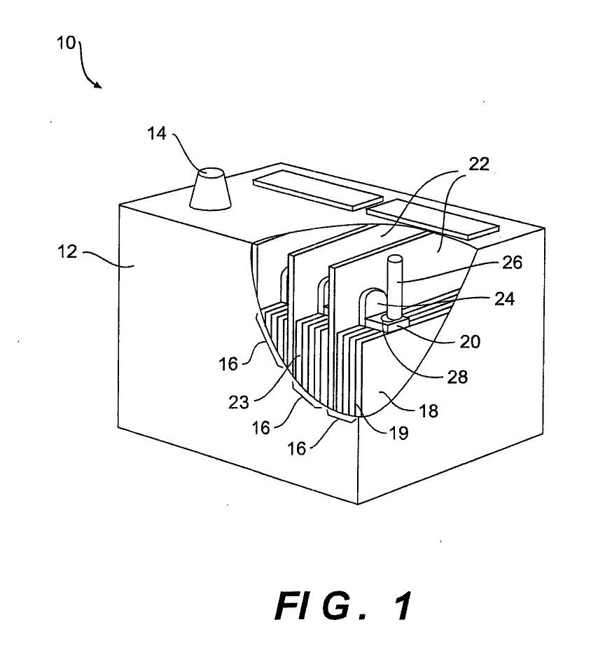

FIG. 1 provides a diagrammatic illustration of an energy storage device 10, according to an exemplary disclosed embodiment. Energy storage device 10 may include various types of batteries. For example, in one embodiment, energy storage device 10 may include a lead acid battery. Other battery chemistries, however, may be used, such as those based on nickel, lithium, sodium-sulfur, zinc, metal hydrides or any other suitable chemistry or materials that can be used to provide an electrochemical potential.

As illustrated in FIG. 1, energy storage device 10 may include a housing 12, terminals 14 (only one shown), and cells 16. Each cell 16 may include one or more positive plates 18 and one or more negative plates 19. In a lead acid battery, for example, positive plates 18 and negative plates 19 may be stacked in an alternating fashion. In each cell 16, a bus bar 20 may be provided to connect positive plates 18 together. A similar bus bar (not shown) may be included to connect negative plates 19 together.

Each cell 16 may be electrically isolated from adjacent cells by a cell separator 22. Moreover, positive plates 18 may be separated from negative plates 19 by a plate isolator 23. Both cell separators 22 and plate isolators 23 may be made from electrically insulating materials that minimize the risk of two adjacent electrical conductors shorting together. To enable the free flow of electrolyte and/or ions produced by electrochemical reactions in energy storage device 10, however, cell separators 22 and plate isolators 23 may be made from porous materials or materials conducive to ionic transport.

Depending on the chemistry of energy storage device 10, each cell 16 will have a characteristic electrochemical potential. For example, in a lead acid battery used in automotive and other applications, each cell may have a potential of about 2 volts. Cells 16 may be connected in series to provide the overall potential of the battery. As shown in FIG. 1, an electrical connector 24 may be provided to connect positive bus bar 20 of one cell 16 to a negative bus bar of an adjacent cell. In this way, six lead acid cells may be linked together in series to provide a desired total potential of about 12 volts, for example. Alternative, electrical configurations may be possible depending on the type of battery chemistry employed and the total potential desired.

Once the total desired potential has been provided using an appropriate configuration of cells 16, this potential may be conveyed to terminals 14 on housing 12 using terminal leads 26. These terminal leads 26 may be electrically connected to any suitable electrically conductive components present in energy storage device 10. For example, as illustrated in FIG. 1, terminal leads 26 may be connected to positive bus bar 20 and a negative bus bar of another cell 16. Each terminal lead 26 may establish an electrical connection between a terminal 14 on housing 12 and a corresponding positive bus bar 20 or negative bus bar (or other suitable electrically conductive elements) in energy storage device 10.

Energy storage device 10 may include aqueous or solid electrolytic materials that at least partially fill a volume between positive plates 18 and negative plates 19. In a lead acid battery, for example, the electrolytic material may include an aqueous solution of sulfuric acid and water. Nickel-based batteries may include alkaline electrolyte solutions that include a base, such as potassium hydroxide, mixed with water. It should be noted that other acids and other bases may be used to form the electrolytic solutions of the disclosed batteries.

Electrode plates 18 and 19 may each include a current collector and an active material disposed on the current collector. As previously mentioned, the role of the current collectors is to collect and transfer the electrons generated by the electrochemical reaction that, at least in some battery chemistries, occurs in the chemically active material during the discharge and charging processes.

The composition of the chemically active material may depend on the chemistry of energy storage device 10. In a lead acid battery, for example, the active material may include an oxide or salt of lead. As additional examples, the anode plates (i.e., positive plates) of nickel cadmium (NiCd) batteries may include a cadmium hydroxide (Cd(OH)₂) active material; nickel metal hydride batteries may include a lanthanum nickel (LaNi₅) active material; nickel zinc (NiZn) batteries may include a zinc hydroxide (Zn(OH)₂) active material; and nickel iron (NiFe) batteries may include an iron hydroxide (Fe(OH)₂) active material. In all of the nickel-based batteries, the chemically active material on the cathode (i.e., negative) plate may be nickel hydroxide.

Instead of using traditional materials in the electrical components of energy storage device 10, various components in energy storage device 10 may be made from electrically conductive phosphate glass. This phosphate glass may include a phosphate binder material having a general chemical formula of AB(PO₄), where A is a first metallic material selected from one of Al, Fe, and oxides thereof, and B is a second metallic material selected from one of Cr, Mo, Cu, V, Mn, and oxides thereof. In order to make the phosphate glass electrically conductive, the phosphate glass binder material may be loaded (e.g., doped) with an electrically conductive material.

Various metals and other electrically conductive materials may be used as the doping agents. In certain embodiments, the doping agent may include silver. For example, silver particles having a size of about 5 microns or less may be dispersed in the phosphate glass binder material in an amount of between about 8 percent by volume and about 70 percent by volume. Resistivity values for the silver doped phosphate glass material may decrease as the amount of silver loaded into the binder material increases. For example, even at relatively low loading of about 8 percent by volume Ag, the electrically conductive phosphate glass may have a resistivity value of about 6 ohm-cm. At loading amounts of about 17 percent Ag by volume and above, the resistivity may be 0.1 ohm-cm or less.

Alternatively, the doping agent may include carbon. In certain exemplary embodiments, carbon particles may be dispersed in the binder material in an amount of between about 5 weight percent and about 50 weight percent. In a preferred range, carbon particles may be included in the binder material in an amount of between about 11 percent by weight to about 40 percent by weight.

An electrically conductive phosphate glass material may result from the addition of carbon to the phosphate glass binder. In certain embodiments with relatively low carbon loading (e.g., at about 11 percent by weight or more), the resistivity of the electrically conductive phosphate glass may be about 1 ohm-cm or less. In still other embodiments (e.g., from 20 percent by weight up to values approaching or including 40 percent by weight), the resistivity of the electrically conductive phosphate glass may be about 0.1 ohm-cm, or less. In certain cases, the resistivity of the electrically conductive phosphate glass may be about 0.003, which is similar to the resistivity of certain forms of graphite.

Various forms of carbon may be used as the doping agent in the binder material. For example, carbon particles or, alternatively, graphite particles, may be dispersed in the binder material. These particles can take the form of fibers, chunks, flakes, or any other suitable configuration. Moreover, various sizes of carbon particles may be included in the binder material. In certain embodiments, the particles may be sized from about 100 nm to about 50 microns.

Broadly, any electrically conductive component in energy storage device 10 may be made to include (in whole or in part) the disclosed electrically conductive phosphate glass. The components made from electrically conductive phosphate glass may include, for example, terminal leads 26, terminals 14, positive bus bars 20, negative bus bars, the current collectors of positive plates 18 and/or negative plates 19, electrical connectors 24 (i.e., cell connectors that establish an electrically conductive path between two or more cells of energy storage device 10), and any other electrically conductive elements. It should also be noted that energy storage device 10 may include a mix of components made from electrically conductive phosphate glass and components made from traditional materials (e.g., lead in a lead acid battery).

Further, the presently disclosed electrically conductive phosphate glass may be used as a bonding agent to join together one or more electrically conductive components of energy storage device 10. For example, a bonding element 28 including electrically conductive phosphate glass may be used to physically join together terminal lead 26 and positive bus bar 20. Similar connections may be established between various other elements (electrically conductive or non-conductive) within energy storage device 10.

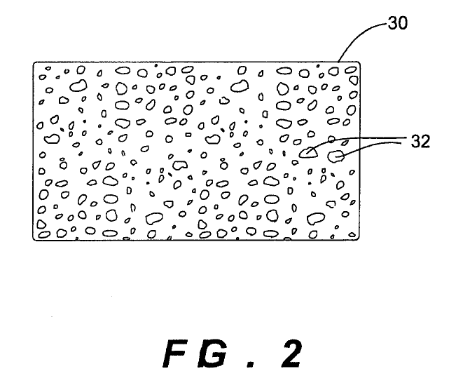

FIG. 2 illustrates a current collector 30 according to an exemplary disclosed embodiment. While it is possible to construct the current collectors of positive plates 18 and/or negative plates 19 from traditional materials (e.g., lead grids in a lead acid battery), in certain embodiments these current collectors may be formed from a foam having an open pore structure. For example, as illustrated in FIG. 2, current collector 30 may include a plurality of pores 32. These pores 32 can significantly increase the surface area of current collector 30 and may allow penetration of the chemically active material into the open pore structure. As a result, an energy storage device 10 having one or more foam current collectors 30, as illustrated in FIG. 2, may offer improved specific energy values, specific power values, and charge/discharge rates, as compared to traditional configurations not including foam current collectors.

In one embodiment, current collector 30 may be made by forming the electrically conductive phosphate glass material described above with a foam configuration. Alternatively, one or more current collectors in energy storage device 10 may include carbon foam or graphite foam.

In the disclosure that follows, a process for making the disclosed electrically conductive phosphate glass components (both in solid and foam configurations) of energy storage device 10 will be described. As a preliminary matter, it should be noted that the curing temperature for a material is a temperature necessary to transform a green material (i.e., an uncured material) into a material having a desired set of characteristics and properties. The operating temperature refers to an upper temperature limit below which a given material maintains a particular property or characteristic. For example, an operating temperature may be marked by a temperature where a material melts or begins to soften to a point where desired structural characteristics of the material are degraded below a predetermined level. In addition to structural properties, the operating temperature may be related to any temperature-dependent characteristic of a material.

In general, the process for making an electrically conductive component of energy storage device 10 includes first preparing a phosphate binder. Next, carbon, silver, or other conductive particles are added to the phosphate binder. At this stage, the consistency of the green material, which is an uncured mixture including the carbon and/or silver particles dispersed in the phosphate binder, may be adjusted to suit a desired application Of the material. Details relating to varying the consistency of the green material are provided below. Further, if desired, the green material may also be formed into a predetermined shape (e.g., molding into a shape appropriate for terminal leads 26, bus bar 20, and other electrically conductive components of energy storage device 10). The green material is then dried and subsequently cured. During the curing step, the temperature of the green material is slowly raised. The rising temperature forces the release of any water remaining in the mixture after the drying step. Ultimately, the temperature reaches a “false melt” temperature. At this temperature, an irreversible structural change occurs in the green material. Tightly held water is released from the green material, which allows a reconfiguration of the chemical bonds between the constituents of the mixture. Subsequent to achieving the false melt temperature, the green material hardens into a stable, electrically conductive material.

Returning to the details of preparing the phosphate binder, preparation of the phosphate binder may begin with a solution of phosphoric acid and water. Adjusting the pH of this solution will affect the physical characteristics of the phosphate binder, which directly influences the physical characteristics of the green material. In general, as the pH is decreased, the resulting green material will be softer due to the retention of additional water within the structure. For example, a pH of approximately 0.85 will yield a green material that remains flexible and pliable even after drying. As the pH is increased, however, the resulting green material becomes denser, and upon drying, the green material eventually becomes hard and non-pliable.

Once the desired pH of the phosphoric acid-based solution has been obtained, a first metal oxide may be dissolved into the solution. In one exemplary embodiment, this first metal oxide may include chromium oxide. In yet another embodiment, molybdenum oxide may be substituted for chromium oxide. Next, a second metal oxide is added to the solution. In an exemplary embodiment, this second metal oxide may include aluminum oxide. In yet another embodiment, the second metal oxide may include iron oxide. The second metal oxide may be added to the solution in forms ranging from a solid block of material to nanometer-scale particles.

The second metal oxide slowly dissolves into the solution. As it dissolves, hydrogen atoms of the phosphoric acid are replaced with metal ions from both the first and second metal oxides, thus liberating hydrogen atoms. Over time, the mixture develops an amorphous, glass-like structure through substitution of the hydrogen atoms in the acid. The presence of the first metal oxide encourages the growth of the glass structure by interrupting crystal formation that may otherwise occur. The reaction is suitably complete when no further gas is evolved from the mixture and a skin forms over the solution upon exposure to air. Any unreacted solids are centrifuged out, and the resultant syrup-like liquid represents the phosphate binder. As noted above, this phosphate binder has a chemical formula AB(PO₄), where A is selected from one of Al, Fe, and oxides thereof, and B is selected from one of Cr, Mo, Cu, V, Mn, and oxides thereof.

As the next step of forming the electrically conductive phosphate glass, electrically conductive particles (e.g., carbon and/or silver) may be added to the phosphate binder. At this stage, the phosphate binder and conductive particle mixture may take on the consistency of a thick paste. Optionally, the consistency of the mixture may be adjusted by adding acidified water (e.g., a solution of water and phosphoric acid) to the mixture. Through addition of the acidified water, the viscosity of the mixture may be reduced. The reduced viscosity may be useful, for example, in forming bonding elements 28 that attach various electrically conductive components together. The additional acid present in the mixture may even aid in producing a stronger false melt during curing. It is possible, however, that too much acidified water at this stage can actually hinder the occurrence of the false melt transition. In general, an addition of acidified water in an amount of up to about 10-15% by volume will not impede the false melt process.

Once the resulting mixture has the desired consistency, the mixture may be formed into a desired shape. For example, at this stage, the mixture may be molded or shaped to form any desired electrically conductive component of energy storage device 10.

Next, the material may be dried at a temperature of up to about 110 degrees C. (e.g., 105 degrees C.) for a predetermined length of time. For example, in an exemplary embodiment, the material could be dried for one or more weeks. Drying times, however, vary depending on the accuracy of the binder mixture, the amount of water lost from the binder during processing, the dimensions of the part being formed, and oven configuration, etc. Therefore, drying times of significantly less or significantly more than two weeks may be possible. By drying the material, a sufficient amount of water is removed from the element to form a stable unitary mass. For example, after drying, the material may include a moisture content of about 0.5% to about 1% water by volume. It is even possible to re-hydrate the material after drying by placing the material into a humidity chamber.

During drying, pressure may be applied to the material, through a die of a mold for example, to densify the material to a predetermined porosity level and to deform the material to predetermined final dimensions. As discussed previously, subsequent to drying, the material may exhibit a range of structural properties depending on the conditions of the initial preparation of the phosphate binder, as well as whether or not any additional acidified water was added after forming the phosphate binder/conductive particle mixture. For example, the material may be flexible and pliable, or it may be more rigid.

Once the material has been dried, it is ready for curing. The curing process proceeds by ramping the temperature of the material upward such that the mixture is ultimately subjected to a curing temperature of greater than about 180 degrees C., which is the approximate temperature where the false melt transition occurs, but less than about 230 degrees C. In the exemplary embodiment, the temperature is increased to the false melt transition temperature, or moderately above, over approximately one hour. Of course, this time will vary according to shape and configuration of the material being cured. For example, the temperature of thin materials may be increased more quickly than for thicker parts having complex shapes. By slowly increasing the temperature of the material over, for example, one hour, water that is trapped within the structure of the material is allowed sufficient time to diffuse through the material as molecular water without damaging the material. Once the false melt transition has occurred and the material is cooled, it is ready for use.

The term “false melt” refers to a change in the material upon heating to a specific transition temperature. At or around this transition temperature, the material temporarily takes on plastic properties and mimics a melt. Unlike a true melt, which occurs at a much higher temperature and where the composition of the material is unchanged, some material is lost during the “false melt”. In theory, at the false melt transition temperature, sufficient energy has been introduced into the system to release chemical bonds and/or tightly held water that is not affected by drying at lower temperatures. The phosphate binder, which is still partly hydrated after drying, is momentarily dissolved in the newly released water and the mixture softens. Once the released water has escaped from the material, the material hardens into a stable form. The false melt transition is irreversible (i.e., the material cannot be re-hydrated). Because very little water is actually involved, a minimal amount of porosity due to water loss results.

Once cured, the resulting material is a dense, hard, and electrically conductive phosphate glass. While the material can be cured at a relatively low temperature of, for example, about 180 degrees C., the material has an operating temperature of up to about 900 degrees C.

Instead of processing the material to achieve minimal porosity, which may be useful for some electrically conductive components, an alternative process may be used to actually create a foam of electrically conductive phosphate glass (e.g., for use in current collectors of energy storage device 10). In the curing process described above, the temperature of the material may be ramped up to above about 180 degrees C. over a time period of about 1 hour. This relatively slow temperature increase can provide sufficient time to allow water to diffuse through the material as molecular water without damaging the material. To create a electrically conductive phosphate glass foam, the temperature of the material may be increased more rapidly during curing. For example, heating the material up to about 180 degrees C. over a time period of about 5 minutes causes water to bubble out of the material leaving behind an open pore structure in the material.

While a 5 minute time period may be used to create the foam in one exemplary embodiment, other time periods may be used depending on the final foam structure desired. Particularly, if larger pores are desired, the material may be heated over a time period of shorter duration. Conversely, if smaller pores are desired, the material may be heated over a longer time duration. Further, a desired total porosity amount of the electrically conductive glass can be achieved by controlling the amount of time the material is maintained at an elevated temperature, which, ultimately, controls the amount of water that is retained in the final material.

Making at least one of the electrically conductive components of energy storage device 10 from the disclosed electrically conductive phosphate glass can offer several benefits. For example, the phosphate glass superstructure is an acid-derived structure and, therefore, provides intrinsic stability to acidic conditions, as in a lead acid battery. Further, the conductivity of the phosphate glass material is adjustable. More or less conductivity can be achieved by incorporating various amounts and types of conductive particles. In certain embodiments, the disclosed materials may offer conductivity values similar to that of pure graphite.

Electrically conductive phosphate glass is relatively light and, in fact, has a density of only about one-fifth the density of lead. Thus, batteries that incorporate one or more electrically conductive phosphate glass components may offer significant weight reductions compared to traditional battery configurations.

Electrically conductive phosphate glass is a stable material that is not susceptible to corrosion, even in the harsh environment of a lead acid battery. Thus, the use of electrically conductive phosphate glass in a battery has the potential to lengthen the service life of the battery. Moreover, reliability may be improved by reducing corrosion-induced failures.

It will be apparent to those skilled in the art that various modifications and variations can be made to the disclosed energy storage device without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. An electrode plate for an energy storage device, comprising:
a current collector fabricated at least partially from an electrically conductive phosphate glass; and
a chemically active material disposed on the current collector.

2. The electrode plate of claim 1, wherein the electrically conductive phosphate glass includes carbon in an amount of between about 5 weight percent and about 50 weight percent.

3. The electrode plate of claim 2, wherein the electrically conductive phosphate glass includes a binder material having a chemical formula of AB(PO₄), where A is a first metallic material selected from one of Al, Fe, and oxides thereof, and B is a second metallic material selected from one of Cr, Mo, Cu, V, Mn, and oxides thereof, and the carbon is present in the form of particles dispersed in the binder material.

4. The electrode plate of claim 2, wherein the carbon includes graphite particles.

5. The electrode plate of claim 1, wherein the electrically conductive phosphate glass has a resistivity of 1.0 ohm-cm or less.

6. The electrode plate of claim 1, wherein the electrically conductive phosphate glass has a resistivity of 0.1 ohm-cm or less.

7. The electrode plate of claim 1, wherein the electrically conductive phosphate glass comprises a foam having an open pore structure.

8. The electrode plate of claim 1, wherein the chemically active material includes an oxide of lead.

9. The electrode plate of claim 1, wherein the electrically conductive phosphate glass includes a binder having a chemical formula of AB(PO₄), where A is a first metallic material selected from one of Al, Fe, and oxides thereof, and B is a second metallic material selected from one of Cr, Mo, Cu, V, Mn, and oxides thereof, and silver particles are dispersed in the binder in an amount of between about 8 weight percent and about 70 weight percent.

10. An energy storage device, comprising:
a housing;
at least one cell disposed within the housing, the at least one cell including one or more positive electrode plates and one or more negative electrode plates; and
at least one component of the energy storage device fabricated from a material including an electrically conductive phosphate glass.

11. The energy storage device of claim 10, wherein the energy storage device is a lead acid battery.

12. The energy storage device of claim 10, wherein the at least one component includes a current collector of the one or more positive electrode plates.

13. The energy storage device of claim 10, wherein the at least one component includes a current collector of the one or more negative electrode plates.

14. The energy storage device of claim 10, wherein the at least one component includes a bus bar that forms at least a portion of an electrically conductive path between at least two of the positive electrode plates or between at least two of the negative electrode plates.

15. The energy storage device of claim 10, further including at least one terminal disposed on the housing; and
wherein the at least one component includes a terminal lead that forms at least a portion of an electrically conductive path between the at least one terminal disposed on the housing and any electrically conductive element disposed within the housing.

16. The energy storage device of claim 10, wherein the at least one component includes an electrical connector that establishes at least a portion of an electrically conductive path between two or more cells of the energy storage device.

17. The energy storage device of claim 10, wherein the at least one component includes a bonding agent physically securing together two or more electrically conductive elements in the energy storage device.

18. The energy storage device of claim 10, wherein the electrically conductive phosphate glass includes:
a binder material having a chemical formula of AB(PO₄), where A is a first metallic material selected from one of Al, Fe, and oxides thereof, and B is a second metallic material selected from one of Cr, Mo, Cu, V, Mn, and oxides thereof; and
carbon dispersed in the binder material in an amount of between about 5 weight percent and about 50 weight percent.

19. The energy storage device of claim 18, wherein the carbon includes graphite particles.

20. The energy storage device of claim 10, wherein the electrically conductive phosphate glass has a resistivity of 1.0 ohm-cm or less.

21. The energy storage device of claim 10, wherein the electrically conductive phosphate glass comprises a foam having an open pore structure.

22. The energy storage device of claim 10, wherein at least one of the one or more positive electrode plates or the one or more negative electrode plates includes a current collector made from carbon foam.

23. A lead acid battery, comprising:
a housing;
at least one cell disposed within the housing and including at least one positive plate and at least one negative plate; and
an electrolytic solution disposed within a volume between the positive and negative plates;
wherein the at least one positive plate or the at least one negative plate further includes:
a current collector fabricated at least partially from a material including electrically conductive phosphate glass, and
a chemically active material disposed on the current collector.

24. The lead acid battery of claim 23, wherein the electrically conductive phosphate glass includes:
a binder material having a chemical formula of AB(PO₄), where A is a first metallic material is selected from one of Al, Fe, and oxides thereof, and B is a second metallic material selected from one of Cr, Mo, Cu, V, Mn, and oxides thereof; and
carbon dispersed in the binder material in an amount of between about 5 weight percent and about 50 weight percent.

25. The lead acid battery of claim 23, further including at least one other electrically conductive component of the battery fabricated from a material including electrically conductive phosphate glass.

26. The lead acid battery of claim 25, wherein the at least one other electrically conductive component includes a terminal lead, a bus bar, or an electrical connector.

27. The lead acid battery of claim 23, wherein the electrically conductive phosphate glass comprises a foam having an open pore structure.
